(19) United States
(12) Patent Application Publication
(10) Pub. No.: US 2018/0083257 A1
(43) Pub. Date: Mar. 22, 2018

(54) BATTERY PROTECTION CIRCUIT PACKAGE AND BATTERY PACK INCLUDING SAME

(71) Applicant: ITM SEMICONDUCTOR CO., LTD., Chungcheongbuk-do (KR)

(72) Inventors: Hyuk hwi NA, Chungcheongbuk-do (KR); Ho Seok HWANG, Gyeonggi-do (KR); Young Seok KIM, Chungcheongbuk-do (KR); Sang Hoon AHN, Chungcheongbuk-do (KR)

(21) Appl. No.: 15/565,692

(22) PCT Filed: Feb. 25, 2016
(86) PCT No.: PCT/KR2016/001862

§ 371 Date: Oct. 11, 2017

(30) Foreign Application Priority Data
Apr. 13, 2015 (KR) 10-2015-0051783

(51) Int. Cl. H01M 2/34; H01M 10/42; H01M 2/30; H02J 7/00

(52) U.S. Cl. CPC H01M 2/34; H01M 10/425; H01M 2/30; H02J 7/0029; H02J 2007/004; H01M 2200/00; H02J 2007/0037; H02J 2007/0039; H01M 2220/30

(57) ABSTRACT

Provided is a battery protection circuit package capable of effectively preventing overcurrent and overheating and of being implemented at low costs in a compact size, the battery protection circuit package including a first terminal and a second terminal electrically connected to electrode terminals of a battery bare cell, a third terminal and a fourth terminal electrically connected to a charger or an electronic device, a first protection circuit module including one or more first transistors connected between at least one of the first and second terminals and at least one of the third and fourth terminals, and a first protection integrated circuit (IC) for controlling the one or more first transistors, and a second protection circuit module including one or more second transistors connected between at least one of the first and second terminals and at least one of the third and fourth terminals and connected in series to the one or more first transistors, and a second protection IC for controlling the one or more second transistors.

### TECHNICAL FIELD

The present invention relates to a battery for an electronic device and, more particularly, to a battery protection circuit package for protecting a battery cell, and a battery pack including the battery protection circuit package.

### BACKGROUND ART

A battery is generally used in electronic devices such as a mobile phone and a personal digital assistant (PDA). As a battery most commonly used in mobile devices, etc., a lithium ion battery is heated when overcharge or overcurrent occurs, and even has the risk of explosion as well as performance degradation if heating is continued and temperature thereof is increased. Accordingly, the battery should include a battery protection circuit apparatus for blocking operation of the battery to prevent the performance degradation.

In general, a thermistor, e.g., a positive temperature coefficient (PTC) thermistor, is added to a battery protection circuit apparatus to block overcurrent and overheating. The PTC thermistor may be produced, for example, by dispersing conductive particles in crystalline polymer. The PTC thermistor serves as a current path between conductive connection members at a set temperature or below. However, if overcurrent occurs and thus a battery is heated above the set temperature, the crystalline polymer expands, connection among the conductive particles dispersed in the crystalline polymer is released, and a resistance is rapidly increased. Therefore, the flow of current between the conductive connection members is blocked or reduced. Since the PTC thermistor may block the flow of current, the PTC thermistor serves as a safety apparatus capable of preventing rupture of the battery. If the battery is cooled to the set temperature or below, the crystalline polymer of the PTC thermistor contracts, connection among the conductive particles is restored, and thus current may flow appropriately. However, the PTC thermistor increases a total production cost due to high-priced parts thereof, and also increases a battery size.

### DETAILED DESCRIPTION OF THE INVENTION

### Technical Problem

The present invention provides a battery protection circuit package and a battery pack capable of effectively blocking overcurrent and/or overheating and of easily achieving integration and size reduction. However, the scope of the present invention is not limited thereto.

### Technical Solution

According to an aspect of the present invention, there is provided a battery protection circuit package including a substrate including a pair of internal connection terminals electrically connectable to electrode terminals of a battery bare cell and a pair of external connection terminals electrically connected to a charger or an electronic device, and a first protection circuit module and a second protection circuit module mounted on at least a part of the substrate, wherein the first protection circuit module includes one or more first transistors connected between at least one of the pair of internal connection terminals and at least one of the pair of external connection terminals, and a first protection integrated circuit (IC) for controlling the one or more first transistors, and wherein the second protection circuit module includes one or more second transistors connected between at least one of the pair of internal connection terminals and at least one of the pair of external connection terminals and connected in series to the one or more first transistors, and a second protection IC for controlling the one or more second transistors.

The one or more first transistors may include a first field-effect transistor (FET) and a second FET connected in series to each other.

The first protection circuit module may further include one or more first passive devices connected to the first protection IC.

The one or more second transistors may include a third FET and a fourth FET connected in series to each other.

The second protection circuit module may further include one or more second passive devices connected to the second protection IC.

At least one of the first and second protection circuit modules may operate as an overcurrent protection apparatus to replace a positive temperature coefficient (PTC) thermistor.

The first protection IC of the first protection circuit module may control the one or more first transistors to control overcharge and/or overdischarge of the battery bare cell, and the second protection IC of the second protection circuit module may control the one or more second transistors to block overcurrent from flowing through the battery bare cell.

The first and second protection circuit modules may include equal circuit devices.

According to another aspect of the present invention, there is provided a battery pack including a battery bare cell, and a battery protection circuit package electrically connected to the battery bare cell, wherein the battery protection circuit package includes a first terminal and a second terminal electrically connected to electrode terminals of a battery bare cell, a third terminal and a fourth terminal electrically connected to a charger or an electronic device, a first protection circuit module including one or more first transistors connected between at least one of the first and second terminals and at least one of the third and fourth terminals, and a first protection integrated circuit (IC) for controlling the one or more first transistors, and a second protection circuit module including one or more second transistors connected between at least one of the first and second terminals and at least one of the third and fourth terminals and connected in series to the one or more first transistors, and a second protection IC for controlling the one or more second transistors.

### Advantageous Effects

As described above, according to embodiments of the present invention, a battery protection circuit capable of effectively preventing overcurrent and overheating, a battery protection circuit package and a battery pack capable of implementing the battery protection circuit at low costs in a compact size may be provided. However, the scope of the present invention is not limited to the above-described effect.

### DESCRIPTION OF THE DRAWINGS

FIG. 1 is a circuit diagram of a battery protection circuit package according to an embodiment of the present invention.

FIG. 2 is a perspective view of the battery protection circuit package according to an embodiment of the present invention.

FIG. 3 is a perspective view of a battery pack according to an embodiment of the present invention.

FIGS. 4 to 8 are partial structural views of battery protection circuit packages according to other embodiments of the present invention.

### MODE OF THE INVENTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses of layers are exaggerated for clarity.

In embodiments of the present invention, a lead frame refers to a metal frame on which lead terminals are patterned, and may differ from a printed circuit board (PCB) in which a metal wiring layer is provided on an insulating core, in terms of structure or thickness thereof.

In the following description, like reference numerals may denote like circuits between battery protection circuits but may denote like elements or circuit parts between battery protection circuit packages.

An integrated circuit (IC) may refer to an electronic part in which a large number of elements are integrated into a chip to process a certain complex function.

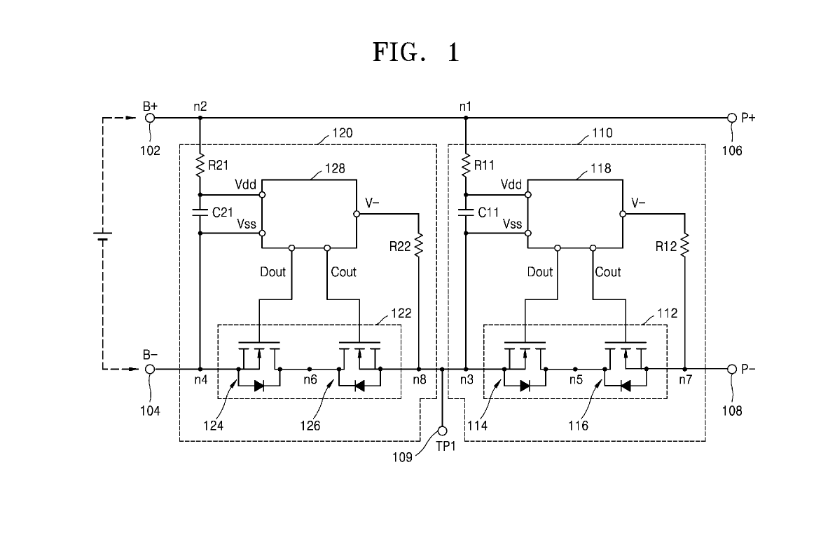

FIG. 1 is a circuit diagram of a battery protection circuit package according to an embodiment of the present invention.

Referring to FIG. 1, the battery protection circuit package according to the current embodiment of the present invention may include a first terminal 102 and a second terminal 104 electrically connected to electrode terminals of a battery bare cell, and a third terminal 106 and a fourth terminal 108 electrically connected to a charger or an electronic device. For example, the first terminal 102 may be an internal positive terminal B+ connected to a positive electrode of the battery bare cell inside a battery pack, the second terminal 104 may be an internal negative terminal B− connected to a negative electrode of the battery bare cell, the third terminal 106 may be an external positive terminal P+ connected to a positive electrode of the charger or the electronic device outside the battery pack, and the fourth terminal 108 may be an external negative terminal P− connected to a negative electrode of the charger or the electronic device. As such, the first and second terminals 102 and 104 electrically connected to the electrode terminals of the battery bare cell may be understood as a pair of internal connection terminals of the battery protection circuit package, and the third and fourth terminals 106 and 108 electrically connected to the charger or the electronic device may be understood as a pair of external connection terminals P+ and P−.

The battery protection circuit package according to an embodiment of the present invention may further include an additional external connection terminal. For example, a test terminal TP1 connected to nodes n3 and n8 between a first protection circuit module 110 and a second protection circuit module 120 may be configured as an external connection terminal. The test terminal TP1 may be an external connection terminal for testing whether charge/discharge or operation of the battery bare cell is effectively blocked, by detecting overdischarge, overcharge, and/or overcurrent of the battery in a package state.

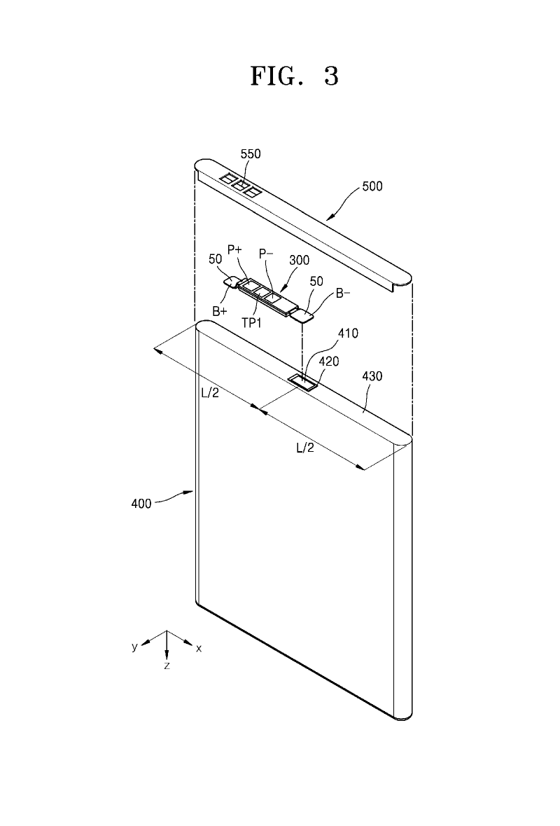

Examples of the above-described external connection terminals P+, P−, and TP1 are shown in a battery protection circuit package 300 illustrated in FIG. 3.

The first protection circuit module 110 may include one or more first transistors 112 connected between at least one of the first and second terminals 102 and 104 and at least one of the third and fourth terminals 106 and 108, and a first protection integrated circuit (IC) 118 for controlling the first transistors 112. For example, the first transistors 112 may be connected between the second and fourth terminals 104 and 108, and the first protection IC 118 may be electrically connected to at least gate terminals of the first transistors 112 to control the first transistors 112.

The second protection circuit module 120 may include one or more second transistors 122 connected between at least one of the first and second terminals 102 and 104 and at least one of the third and fourth terminals 106 and 108, and a second protection IC 128 for controlling the second transistors 122. For example, the second transistors 122 may be connected between the second and fourth terminals 104 and 108, and the second protection IC 128 may be electrically connected to at least gate terminals of the second transistors 122 to control the second transistors 122. The first and second transistors 112 and 122 may be connected in series to each other.

The first protection circuit module 110 and/or the second protection circuit module 120 may block charge/discharge or operation of the battery bare cell by detecting overdischarge, overcharge, and/or overcurrent of the battery. The first and second protection circuit modules 110 and 120 may be used complementarily to each other. For example, the first and second protection circuit modules 110 and 120 may be configured in series and may equally operate to block charge/discharge or operation of the battery bare cell by detecting overdischarge, overcharge, and/or overcurrent of the battery. As such, even when one of the first and second protection circuit modules 110 and 120 has an error, the battery may be protected using the other one.

As another example, the first and second protection circuit modules 110 and 120 may be used as functionally different modules. In this case, at least one of the first and second protection circuit modules 110 and 120 may operate to replace a typical overcurrent protection apparatus, e.g., a positive temperature coefficient (PTC) thermistor. For example, one of the first and second protection circuit modules 110 and 120 may control overdischarge and overcharge of the battery, and the other one may control to detect overcurrent.

Specifically, the first protection IC 118 of the first protection circuit module 110 may control the first transistors 112 to control overcharge and/or overdischarge of the battery bare cell, and the second protection IC 128 of the second protection circuit module 120 may control the second transistors 122 to block overcurrent from flowing through the battery bare cell. As another example, the second protection IC 128 of the second protection circuit module 120 may control the second transistors 122 to control overcharge and/or overdischarge of the battery bare cell, and the first protection IC 118 of the first protection circuit module 110 may control the first transistors 112 to block overcurrent from flowing through the battery bare cell.

The configuration and operation of the first protection circuit module 110 will now be described in detail.

The first transistors 112 may include a first field-effect transistor (FET) 114 and a second FET 116 connected in series to each other. For example, the first and second FETs 114 and 116 may be equal-type transistors, e.g., N-type metal-oxide semiconductor field-effect transistors (NMOSFETs), and may be connected in series to share a drain at a node n5 between the second and fourth terminals 104 and 108. As such, at least one reverse diode may be configured between a drain and a source of each of the first and second FETs 114 and 116 to control the flow of current between the second and fourth terminals 104 and 108.

The first protection IC 118 may include a control logic for controlling the first transistors 112, e.g., the first and second FETs 114 and 116. For example, the control logic may include a reference voltage setter, a comparer for comparing a reference voltage to a charge/discharge voltage, an overcurrent detector, and a charge/discharge detector. Conditions for determining charge and discharge states may be changed based on specifications required by a user, and the charge and discharge states are determined based on the conditions by detecting a voltage difference between terminals of the first protection IC 118. For example, to output the control logic, the first protection IC 118 may include a reference terminal Vss, a source terminal Vdd, a detection terminal V−, a discharge blocking signal output terminal Dout, and a charge blocking signal output terminal Cout.

The first protection IC 118 may be connected via one or more passive devices to nodes n1, n3, and n7. For example, the source terminal Vdd may be connected via a resistor R11 to the node n1 between the first and third terminals 102 and 106, and the reference terminal Vss may be connected to the node n3 between the second and fourth terminals 104 and 108. A capacitor C11 for preventing a short circuit between the two nodes n1 and n3 may be interposed between the reference terminal Vss and the source terminal Vdd between the nodes n1 and n3. The detection terminal V− may be connected via a resistor R12 to the node n7.

Based on the above-described configuration, the first protection IC 118 may apply a charge voltage or a discharge voltage through the source terminal Vdd with reference to a voltage of the reference terminal Vss, and detect charge/discharge and overcurrent states through the detection terminal V−.

To control whether to turn on or off the first transistors 112 in a battery discharge operation, the discharge blocking signal output terminal Dout may be connected to the gate of the first FET 114. To control whether to turn on or off the first transistors 112 in a battery charge operation, the charge blocking signal output terminal Cout may be connected to the gate of the second FET 116.

In the battery charge operation, a charge current flows from the third terminal 106 to the first terminal 102, and from the second terminal 104 to the fourth terminal 108. In the battery discharge operation, a discharge current flows from the first terminal 102 to the third terminal 106, and from the fourth terminal 108 to the second terminal 104.

The first protection IC 118 may operate to turn off the first FET 114 by outputting a LOW signal through the discharge blocking signal output terminal Dout when an overcurrent or overdischarge state is detected in the battery discharge operation, or to turn off the second FET 116 by outputting a LOW signal through the charge blocking signal output terminal Cout when an overcurrent or overcharge state is detected in the battery charge operation. As such, since at least one of the first and second FETs 114 and 116 connected in series to each other is turned off, a circuit between the second and fourth terminals 104 and 108 may be cut off to block overcharge, overdischarge, and/or overcurrent of the battery.

The resistor R11 and the capacitor C11 serve to stabilize variations in supply power of the first protection IC 118. When the resistor R11 has a high resistance value, since a high voltage is detected due to a current flowing into the first protection IC 118, the resistance value of the resistor R11 may be set to a value equal to or less than a predetermined value, e.g., 1 KΩ. In addition, for stable operation, a capacitance value of the capacitor C11 may be appropriately adjusted and may have an appropriate value equal to or greater than, for example, 0.01 μF.

The resistors R11 and R12 serve as a current limiter when a charger provides a high voltage exceeding an absolute maximum rating of the first protection IC 118 or when the charger is connected with wrong polarity. Since the resistors R11 and R12 are closely related to power consumption, a sum of resistance values of the resistors R11 and R12 may be set to be greater than 1 KΩ. Since recovery after overcharge is blocked may not occur if the resistance value of the resistor R12 is excessively high, the resistance value of the resistor R12 may be set to a value equal to or less than 10 KΩ.

The capacitor C11 does not exert a strong influence on characteristics of a battery protection circuit product, but is added upon a user request or for stability. The capacitor C11 is used to achieve system stabilization by improving tolerance to voltage variations or external noise.

Optionally, although not shown in FIG. 1, a resistor and a varistor connected in parallel to each other for electrostatic discharge (ESD) and surge protection may be added. The varistor is a device capable of reducing a resistance thereof when overvoltage occurs, thereby minimizing circuit damage due to overvoltage. In the above-described first protection circuit module 110, the number or configuration of passive devices may be appropriately changed depending on functions of the first protection circuit module 110.

The configuration and operation of the second protection circuit module 120 will now be described in detail. For example, the first and second protection circuit modules 110 and 120 may include equal or similar circuit devices, and repeated descriptions therebetween in this case are not provided herein.

The second transistors 122 may include a third FET 124 and a fourth FET 126 connected in series to each other. For example, the third and fourth FETs 124 and 126 may be equal-type transistors, e.g., N-type metal-oxide semiconductor field-effect transistors (NMOSFETs), and may be connected in series to share a drain at a node n6 between the second and fourth terminals 104 and 108. As such, at least one reverse diode may be configured between a drain and a source of each of the third and fourth FETs 124 and 126 to control the flow of current between the second and fourth terminals 104 and 108.

The second protection IC 128 may include a control logic for controlling the second transistors 122, e.g., the third and fourth FETs 124 and 126. For example, the control logic may include a reference voltage setter, a comparer for comparing a reference voltage to a charge/discharge voltage, an overcurrent detector, and a charge/discharge detector. For example, to output the control logic, the second protection IC 128 may include a reference terminal Vss, a source terminal Vdd, a detection terminal V−, a discharge blocking signal output terminal Dout, and a charge blocking signal output terminal Cout.

The second protection IC 128 may be connected via one or more passive devices to nodes n2, n4, and n8. For example, the source terminal Vdd may be connected via a resistor R21 to the node n2 between the first and third terminals 102 and 106, and the reference terminal Vss may be connected to the node n4 between the second and fourth terminals 104 and 108. A capacitor C21 for preventing a short circuit between the two nodes n2 and n4 may be interposed between the reference terminal Vss and the source terminal Vdd between the nodes n2 and n4. The detection terminal V− may be connected via a resistor R22 to the node n8.

Based on the above-described configuration, the second protection IC 128 may apply a charge voltage or a discharge voltage through the source terminal Vdd with reference to a voltage of the reference terminal Vss, and detect charge/discharge and overcurrent states through the detection terminal V−. The first and second protection ICs 118 and 128 may be produced in equal structures due to functional similarity therebetween, but may be produced in partially different structures when functions thereof are different.

To control whether to turn on or off the second transistors 122 in a battery discharge operation, the discharge blocking signal output terminal Dout may be connected to the gate of the third FET 124. To control whether to turn on or off the second transistors 122 in a battery charge operation, the charge blocking signal output terminal Cout may be connected to the gate of the fourth FET 126.

The second protection IC 128 may operate to turn off the third FET 124 by outputting a LOW signal through the discharge blocking signal output terminal

Dout when an overcurrent or overdischarge state is detected in the battery discharge operation, or to turn off the fourth FET 126 by outputting a LOW signal through the charge blocking signal output terminal Cout when an overcurrent or overcharge state is detected in the battery charge operation. As such, since at least one of the third and fourth FETs 124 and 126 connected in series to each other is turned off, a circuit between the second and fourth terminals 104 and 108 may be cut off to block overcharge, overdischarge, and/or overcurrent of the battery.

The resistors R21 and R22 and the capacitor C21 may operate equally to the resistors R11 and R12 and the capacitor C11 of the first protection circuit module 110, and thus repeated descriptions therebetween are not provided herein. However, values of the resistors R21 and R22 and the capacitor C21 of the second protection circuit module 120 may equal the values of the resistors R11 and R12 and the capacitor C11 of the first protection circuit module 110, or may differ therefrom for fine control.

Optionally, although not shown in FIG. 1, a resistor and a varistor connected in parallel to each other for ESD and surge protection may be added. In the above-described second protection circuit module 120, the number or configuration of passive devices may be appropriately changed depending on functions of the second protection circuit module 120.

According to the dual protection circuit configuration of the present invention, since the battery bare cell is protected using a dual protection structure of the first and second protection circuit modules 110 and 120, a typical overcurrent or overheating protection apparatus, e.g., a PTC thermistor or a bimetal junction structure, may be omitted and thus a total volume of the battery protection circuit package may be reduced. The first and second protection circuit modules 110 and 120 may be implemented as semiconductor chips, and thus may be produced to a micrometer or nanometer size using a silicon process technology.

For example, all of the first and second protection ICs 118 and 128 and the first to fourth FETs 114, 116, 124, and 126 may be produced as semiconductor chips and the passive devices, e.g., the resistors R11, R12, R21, and R22 and the capacitors C11 and C21, may be produced as chips. The chip structures may be easily mounted on a substrate using a surface mount technology (SMT).

In an embodiment of the present invention, the first and second protection circuit modules 110 and 120 may perform almost equal functions and may dually protect the battery bare cell. In this case, the first and second protection circuit modules 110 and 120 may have almost equal circuit devices and circuit configurations.

In another embodiment of the present invention, the first and second protection circuit modules 110 and 120 may perform equal or similar functions and may additionally perform different functions. In this case, the first and second protection circuit modules 110 and 120 may mostly have similar circuit devices and circuit configurations and additionally have differences.

In the above-described embodiments of present invention, due to the dual protection circuit configuration of the first and second protection circuit modules 110 and 120, the number of NMOSFETs may be doubled compared to a typical case and thus an internal resistance may be increased. As such, the first to fourth FETs 114, 116, 124, and 126 may be produced to a size two or three times greater than that of typical FETs to reduce the internal resistance to a level of the typical case. However, even in this case, the first to fourth FETs 114, 116, 124, and 126 may have equal or different sizes and specifications.

The battery protection circuit package according to embodiments of the present invention may include a substrate capable of mounting the above-described first and second protection circuit modules 110 and 120 thereon. The substrate may include a lead frame and/or a printed circuit board (PCB). The above-described first and second terminals 102 and 104 configured as a pair of internal connection terminals, and the third and fourth terminals 106 and 108 configured as a pair of external connection terminals may be parts of the substrate or may be conductive structures added to the substrate.

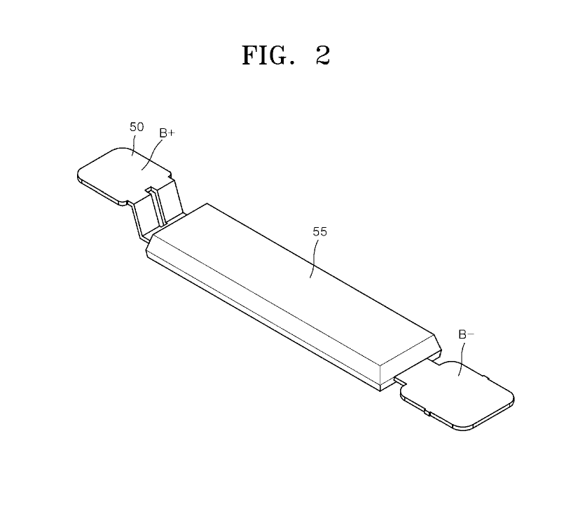

FIG. 2 is a perspective view of the battery protection circuit package according to an embodiment of the present invention.

Referring to FIG. 2, the above-described first and second protection circuit modules 110 and 120 may be mounted on a substrate 50. For example, the substrate 50 may include a PCB and/or a lead frame. The first and second protection circuit modules 110 and 120 may be encapsulated into a single package using a molding material 55. A molding material for encapsulating the first protection circuit module 110 and a molding material for encapsulating the second protection circuit module 120 may be provided integrally or separately.

In a modified embodiment of the current embodiment, each of the first and second protection circuit modules 110 and 120 may be mounted on the substrate 50 in the form of a chip scale package (CSP) to reduce a volume thereof. In this case, each of the first and second protection circuit modules 110 and 120 may be packaged and then mounted on the substrate 50.

In another modified embodiment of the current embodiment, the first protection circuit module 110 may be produced in a stacked package structure or a package on package (POP) structure in which the first protection IC 118 is stacked on the first and second FETs 114 and 116. Likewise, the second protection circuit module 120 may be produced in a stacked package structure or a POP structure in which the second protection IC 128 is stacked on the third and fourth FETs 124 and 126.

FIG. 3 is an exploded perspective view of a battery pack according to an embodiment of the present invention.

Referring to FIG. 3, the battery pack is configured by inserting the battery protection circuit package 300 between an upper case 500 and a top surface of a battery bare cell embedded in a battery can 400. The upper case 500 is made of plastic and/or metal and has through holes 550 through which external connection terminals P+ and P− are exposed.

The battery bare cell includes an electrode assembly and a cap assembly. The electrode assembly may include a positive plate produced by coating a positive current collector with a positive active material, a negative plate produced by coating a negative current collector with a negative active material, and a separator interposed between the positive and negative plates to prevent a short circuit between the two electrode plates and to enable movement of lithium ions. A positive tab attached to the positive plate and a negative tab attached to the negative plate protrude from the electrode assembly.

The cap assembly includes a negative terminal 410, a gasket 420, a cap plate 430, etc. The cap plate 430 may serve as a positive terminal. The negative terminal 410 may also be called a negative cell or an electrode cell. The gasket 420 may be made of an insulating material to insulate the negative terminal 410 and the cap plate 430 from each other. Accordingly, electrode terminals of the battery bare cell may include the negative terminal 410 and the cap plate 430.

Specifically, the electrode terminals of the battery bare cell may include a plate 430 having a first polarity (e.g., a positive polarity), and an electrode cell 410 having a second polarity (e.g., a negative polarity) and located at the center of the plate 430. A first internal connection terminal lead B+ may be bonded and electrically connected to the plate 430, and a second internal connection terminal lead B− may be bonded and electrically connected to the electrode cell 410. In this case, a length of a lead frame 50 may correspond to a length L/2 from an end of the plate 430 to the electrode cell 410.

According to the current embodiment, since the battery protection circuit package 300 is mounted only at a single side of a top surface of the electrode cell 410, a battery size may be reduced or a battery capacitance may be increased. For example, another cell or chip may be further provided at the other side of the electrode cell 410, thereby increasing a battery capacitance or reducing the size of a battery application.

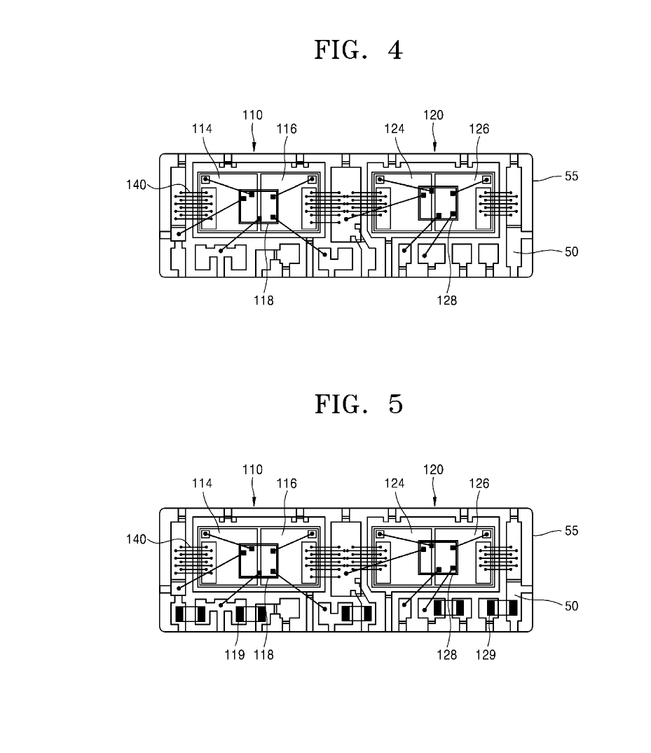

FIGS. 4 to 8 are partial structural views of battery protection circuit packages according to other embodiments of the present invention.

Referring to FIGS. 4 to 7, the first and second protection circuit modules 110 and 120 are mounted on at least a part of the substrate 50. The first protection circuit module 110 may be produced in a stacked package structure or a POP structure in which the first protection IC 118 is stacked on the first and second FETs 114 and 116. Likewise, the second protection circuit module 120 may be produced in a stacked package structure or a POP structure in which the second protection IC 128 is stacked on the third and fourth FETs 124 and 126.

To implement the circuit illustrated in FIG. 1, an electrical connection member 140 may be configured to electrically interconnect any two selected among the first protection IC 118, the first FET 114, the second FET 116, the second protection IC 128, the third FET 124, the fourth FET 126, and the substrate 50. The electrical connection member 140 may include, for example, bonding wire or bonding ribbon.

A first passive device 119 included in the first protection circuit module 110 may include, for example, the resistor R11 or R12 or the capacitor C11 illustrated in FIG. 1. A second passive device 129 included in the second protection circuit module 120 may include, for example, the resistor R21 or R22 or the capacitor C21 illustrated in FIG. 1.

The first passive device 119 included in the first protection circuit module 110 and/or the second passive device 129 included in the second protection circuit module 120 may be directly mounted on the substrate 50 on which the first FET 114, the second FET 116, the first protection IC 118, the third FET 124, the fourth FET 126, and the second protection IC 128 are mounted, or may be mounted on an additional substrate (not shown) other than the substrate 50.

Referring to FIG. 4, for example, a first passive device included in the first protection circuit module 110 and a second passive device included in the second protection circuit module 120 may not be directly mounted on the substrate 50 on which the first FET 114, the second FET 116, the first protection IC 118, the third FET 124, the fourth FET 126, and the second protection IC 128 are mounted, but may be mounted on an additional substrate (e.g., a PCB) bonded to the substrate 50.

Referring to FIG. 5, as another example, the first passive device 119 included in the first protection circuit module 110 and the second passive device 129 included in the second protection circuit module 120 may be directly mounted on the substrate 50 on which the first FET 114, the second FET 116, the first protection IC 118, the third FET 124, the fourth FET 126, and the second protection IC 128 are mounted.

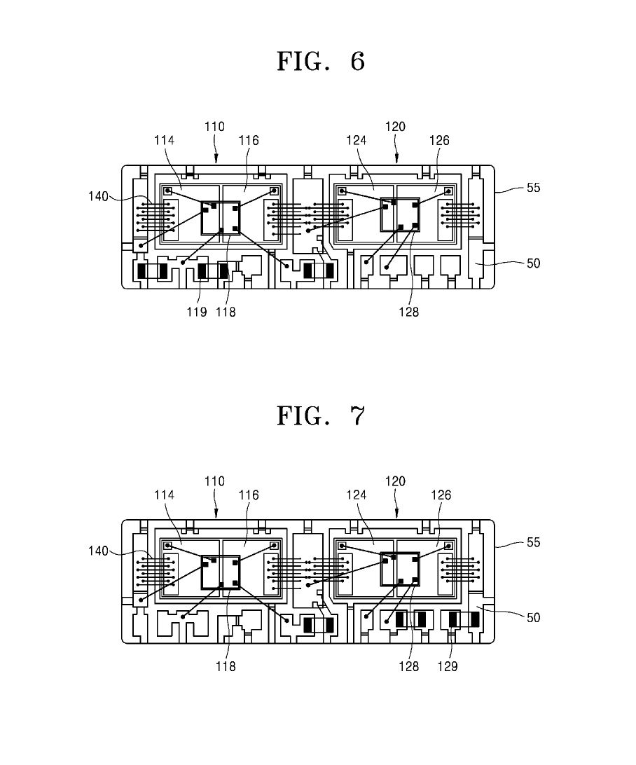

Referring to FIG. 6, as another example, the first passive device 119 included in the first protection circuit module 110 may be directly mounted on the substrate 50 on which the first FET 114, the second FET 116, and the first protection IC 118 are mounted. The second passive device 129 included in the second protection circuit module 120 may not be directly mounted on the substrate 50 on which the third FET 124, the fourth FET 126, and the second protection IC 128 are mounted, but may be mounted on an additional substrate (e.g., a PCB) bonded to the substrate 50.

Referring to FIG. 7, as another example, the second passive device 129 included in the second protection circuit module 120 may not directly mounted on the substrate 50 on which the third FET 124, the fourth FET 126, and the second protection IC 128 are mounted. The first passive device 119 included in the first protection circuit module 110 may not be directly mounted on the substrate 50 on which the first FET 114, the second FET 116, and the first protection IC 118 are mounted, but may be mounted on an additional substrate (e.g., a PCB) bonded to the substrate 50.

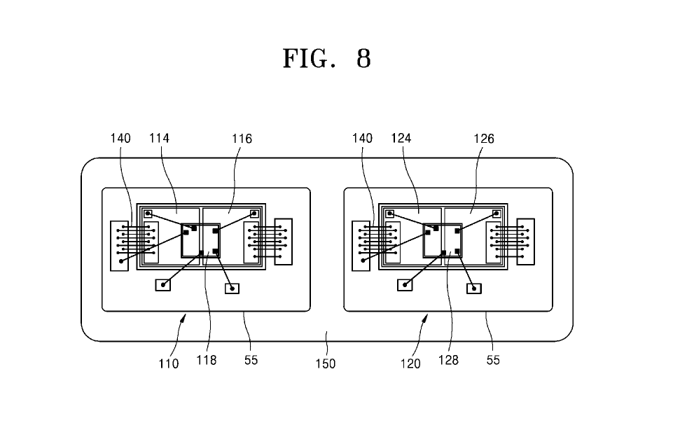

FIG. 8 is a partial structural view of a battery protection circuit package according to another embodiment of the present invention.

Referring to FIG. 8, the first and second protection circuit modules 110 and 120 may be mounted on a PCB 150.

The first protection circuit module 110 may be produced in a stacked package structure or a POP structure in which the first protection IC 118 is stacked on the first and second FETs 114 and 116. Likewise, the second protection circuit module 120 may be produced in a stacked package structure or a POP structure in which the second protection IC 128 is stacked on the third and fourth FETs 124 and 126.

According to a modified embodiment, each of the first and second protection circuit modules 110 and 120 may be mounted on the PCB 150 may be mounted on the PCB 150 in the form of a CSP. In this case, each of the first and second protection circuit modules 110 and 120 may be packaged and then mounted on the PCB 150.

The battery protection circuit package illustrated in FIG. 4, 5, 6, 7, or 8 may be implemented as a single package in a sawing or trimming manner.

A battery protection circuit package according to embodiments of the present invention, and a battery pack including the same have the following effects compared to a product using a typical overcurrent or overheating protection apparatus, e.g., a PTC thermistor.

First, in embodiments of the present invention, overcurrent may be effectively blocked using a low-priced electronic part compared to a PTC thermistor. The PTC thermistor is generally high-priced and thus is a major cause of increasing the production cost of a battery protection circuit apparatus. According to the present invention, the above-described problem may be effectively solved.

Second, since a PTC thermistor is provided outside a battery protection circuit package, a process for bonding the PTC thermistor to the battery protection circuit package is additionally required and structural strength can be reduced due to an error in the bonding process. That is, a process for bonding a metal layer of the PTC thermistor to a lead of the battery protection circuit package using laser welding, resistance welding, or the like is additionally required, and the structural strength of the bonded assembly can be lowered.

While the present invention has been particularly shown and described with reference to embodiments thereof, it will be understood by one of ordinary skill in the art that various changes in form and details may be made therein without departing from the spirit and scope of the present invention as defined by the following claims.

1. A battery protection circuit package comprising:
a substrate comprising a pair of internal connection terminals electrically connectable to electrode terminals of a battery bare cell and a pair of external connection terminals electrically connected to a charger or an electronic device; and
a first protection circuit module and a second protection circuit module mounted on at least a part of the substrate,
wherein the first protection circuit module comprises one or more first transistors connected between at least one of the pair of internal connection terminals and at least one of the pair of external connection terminals, and a first protection integrated circuit (IC) for controlling the one or more first transistors, and
wherein the second protection circuit module comprises one or more second transistors connected between at least one of the pair of internal connection terminals and at least one of the pair of external connection terminals and connected in series to the one or more first transistors, and a second protection IC for controlling the one or more second transistors.

2. The battery protection circuit package of claim 1, wherein the one or more first transistors comprise a first field-effect transistor (FET) and a second FET connected in series to each other.

3. The battery protection circuit package of claim 2, wherein the first protection circuit module further comprises one or more first passive devices connected to the first protection IC.

4. The battery protection circuit package of claim 1, wherein the one or more second transistors comprise a third FET and a fourth FET connected in series to each other.

5. The battery protection circuit package of claim 4, wherein the second protection circuit module further comprises one or more second passive devices connected to the second protection IC.

6. The battery protection circuit package of claim 1, wherein at least one of the first and second protection circuit modules operates as an overcurrent protection apparatus to replace a positive temperature coefficient (PTC) thermistor.

7. The battery protection circuit package of claim 6, wherein the first protection IC of the first protection circuit module controls the one or more first transistors to control overcharge and/or overdischarge of the battery bare cell, and
wherein the second protection IC of the second protection circuit module controls the one or more second transistors to block overcurrent from flowing through the battery bare cell.

8. The battery protection circuit package of claim 1, wherein the first and second protection circuit modules comprise equal circuit devices.

9. The battery protection circuit package of claim 1, further comprising an additional external connection terminal capable of testing whether charge/discharge or operation of the battery bare cell is effectively blocked, by detecting overdischarge, overcharge, and/or overcurrent of a battery,
wherein the additional external connection terminal is electrically connected between the first and second protection circuit modules.

10. A battery pack comprising:
a battery bare cell; and
a battery protection circuit package electrically connected to the battery bare cell, wherein the battery protection circuit package comprises:
a substrate comprising a pair of internal connection terminals electrically connectable to electrode terminals of the battery bare cell and a pair of external connection terminals electrically connected to a charger or an electronic device; and
a first protection circuit module and a second protection circuit module mounted on the substrate,
wherein the first protection circuit module comprises one or more first transistors connected between at least one of the pair of internal connection terminals and at least one of the pair of external connection terminals, and a first protection integrated circuit (IC) for controlling the one or more first transistors, and
wherein the second protection circuit module comprises one or more second transistors connected between at least one of the pair of internal connection terminals and at least one of the pair of external connection terminals and connected in series to the one or more first transistors, and a second protection IC for controlling the one or more second transistors.

11. The battery pack of claim 10, wherein at least one of the first and second protection circuit modules operates as an overcurrent protection apparatus to replace a positive temperature coefficient (PTC) thermistor.
